(19) United States
(12) Patent Application Publication
(10) Pub. No.: US 2008/0057170 A1
(43) Pub. Date: Mar. 6, 2008

(54) BAKING DEVICE AND METHOD THEREOF FOR CONTROLLING A RELIABLE BROWNING LEVEL

(75) Inventors: YU-KAI CHEN, CHIA-YI (TW); CHIN-HSIUNG CHANG, TAICHUNG COUNTY 413 (TW); CHI-REN HUNG, YUNLIN COUNTY 652 (TW); MING-HUI JAO, NANTOU COUNTY 542 (TW)

Correspondence Address: ROSENBERG, KLEIN & LEE, 3458 ELLICOTT CENTER DRIVE-SUITE 101, ELLICOTT CITY, MD, 21043, US

(73) Assignee: FEGO PRECISION INDUSTRIAL CO., LTD., TAICHUNG (TW)

(21) Appl. No.: 11/846,079

(22) Filed: Aug. 28, 2007

(30) Foreign Application Priority Data
Sep. 5, 2006 (TW) 95132782

(51) Int. Cl. A23P 1/00; A47J 37/06

(52) U.S. Cl. 426/416; 99/331

(57) ABSTRACT

The present invention discloses a baking device and method thereof for controlling a reliable browning level and a baking method which controls the parameters of a browning level of a baking device in order to reach the browning level desired by a user. The baking device of the present invention includes a temperature sensor, a weight sensor or an impedance sensor to judge the current browning level of a baked food by the difference in temperature, the weight or the impedance of the baked food. It then compares the results with the reliable browning level stored in the microprocessor of the baking device. The comparing result of the current browning level and the reliable browning are used as a basis of whether to continue to heat the thermal grid or not.

### BACKGROUND OF THE INVENTION

1. Field of the Invention

The present invention relates to a baking device and a baking method thereof, and more especially to a baking device and a baking method thereof for controlling a reliable browning level.

2. Description of the Prior Art

A traditional baking device (such as a toaster or an oven) depends on heating effect of electric current, for example, the primary component of a baking device is a thermal grid made from an Fe—Ni alloy. The resistance coefficient of the Fe—Ni alloy is very large and the Fe—Ni alloy is thinner than copper wire, so electrons movement in the Fe—Ni alloy wire do not easily and collides with other atoms. The collision accelerates the vibrations of the atoms, raising the temperature, and increasing the resistance coefficient, so that the number of electrons is decreased. Because the number of electrons decreases, the amount of vibrations is also reduced. Furthermore, because the vibrations of the atoms are weaker, the strength of the current is raised. Due to the higher current, the vibrations are accelerated, and the temperature is raised again. By the alternation of the two opposite effects, a steady state is reached within several seconds, that is to say, because the two opposite effects counteract each other, the temperature is not raised further, and the current is steady. The heating effect of electric current is red and hot, and the bread is baked.

For instance, ordinary baking devices control the browning level of food (such as toast) to be baked by the timer which is set in advance. However, the browning level of the toast is difficult to control because of the different kinds of bread which may be used and because the initial temperature of the interior of the baking device is not taken into account. This results in burning, over browning or insufficient browning of the bread. When the browning level of the bread is insufficient, the bread is usually put back into the baking device. Unfortunately, the taste of rebaked toast is not as appealing to peoples' tastes.

Following is a comprehensive overview of the baking devices currently available to consumers. Several disadvantages exist, most notably:
1. The browning level is difficult to control, so the browning level desired by a user is difficult to attain;
2. When a desired browning level cannot be reached, it is necessary to put the toast back into the baking device again, so time is wasted; and
3. The browning level of different kinds of bread baked in a baking device for the same period of time may not be the same.

Hence, the inventors of the present invention believe that these shortcomings above are able to be improved upon and finally suggest the present invention which is of a reasonable design and is an effective improvement based on deep research and thought.

### SUMMARY OF THE INVENTION

A baking device and a method thereof for controlling a reliable browning level of the present invention are disclosed to resolve the problem of the browning level being difficult to control.

An object of the present invention is to provide a baking device capable of baking any type of food, and the food needs to be baked just one time to meet the tastes of people.

To achieve the above-mentioned object, a baking device for controlling a reliable browning level of the present invention is disclosed. The baking device includes a power converter converting an input AC power supply into a DC power supply, a thermal unit electrically connected to the power converter to heat up a baked food, a temperature sensor electrically connected to the thermal unit to detect the temperature of the baked food, a environment temperature sensor detecting the interior temperature of the baking device, and a microprocessor electrically connected to the temperature sensor and the environment temperature sensor detects the temperature of the baked food and the interior temperature of the baking device for outputting a control voltage to the power converter.

After a browning level has been selected, a reduced weight owing to the difference in weight lost as the baked food is heated and dries is calculated by the temperature sensor and the microprocessor to define multiple browning levels to suit the tastes of a user.

To further understand features and technical contents of the present invention, please refer to the following detailed description and drawings related the present invention. However, the drawings are only to be used as references and explanations, not to limit the present invention.

### BRIEF DESCRIPTION OF THE DRAWINGS

FIG. 1 is a block diagram of a baking device for controlling a reliable browning level of a first embodiment of the present invention;

FIG. 2 is a block diagram of the interior of the microprocessor of the first embodiment of the present invention;

FIG. 3 is a flow chart of a baking method for controlling a reliable browning level of the first embodiment of the present invention;

FIG. 4 is a block diagram of a baking device for controlling a reliable browning level of a second embodiment of the present invention;

FIG. 5 is a block diagram of the interior of the microprocessor of the second embodiment of the present invention;

FIG. 6 is a flow chart of a baking method for controlling a reliable browning level of the second embodiment of the present invention;

FIG. 7 is a block diagram of a baking device for controlling a reliable browning level of a third embodiment of the present invention;

FIG. 8 is a block diagram of the inner of the microprocessor of the third embodiment of the present invention;

FIG. 9 is a flow chart of a baking method for controlling a reliable browning level of the third embodiment of the present invention; and

FIG. 10 is an impedance-time coordinate of the present invention.

### DETAILED DESCRIPTION OF THE INVENTION

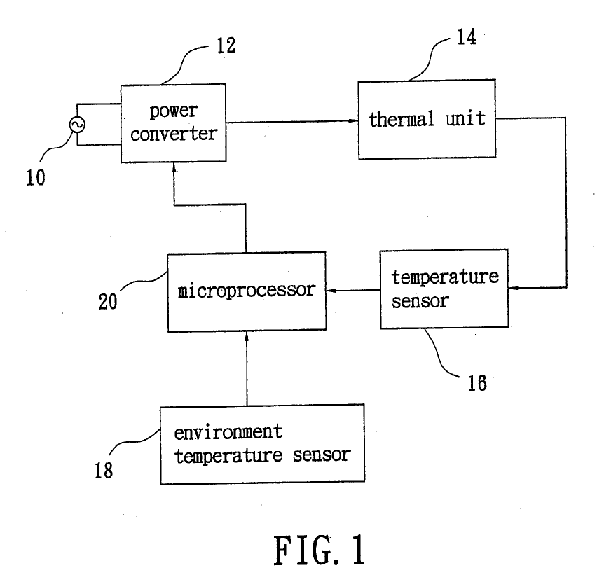

Referring to FIG. 1, a block diagram of a baking device for controlling a reliable browning level of a first embodiment of the present invention is shown. The device includes a power converter 12 converting an input AC power supply 10 into a DC power supply, and the AC power supply 10 may be 110Vrms/60 HZ. A thermal unit 14 is electrically connected to the power converter 12 to heat up a baked food to be baked. The thermal unit 14 may be a thermal grid. A temperature sensor 16 is electrically connected to the thermal unit 14 to detect the temperature of the baked food. An environment temperature sensor 18 detects the interior temperature of the baking device. A microprocessor 20 is electrically connected to the temperature sensor 16 and the environment temperature sensor 18 detects the temperature of the baked food and the interior temperature of the baking device, and then outputs a control voltage to the power converter 12.

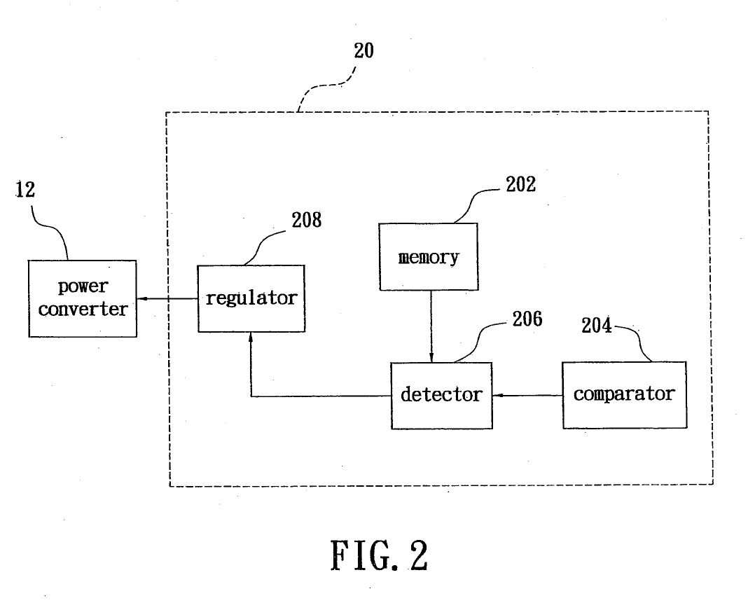

Referring to FIG. 2, a block diagram of the interior of the microprocessor unit 20 of the first embodiment of the present invention is shown. The microprocessor unit 20 includes a memory 202 storing a stable browning level value and a temperature-time-browning converting table, the stable browning level value is provided via a browning level knob of the baking device. The memory 202 may be an EEPROM or a RAM. A comparing element 204 compares the temperature of the baked food and the interior temperature the baking device to provide a current browning level value. The comparing element 204 may be a comparator. A detector 206 converts the value of integrating food temperature with heating time and the interior temperature of baking device into the current browning level value by the temperature-time-browning level converting table. A regulator 208 receives the detecting signal, and then outputs a control voltage to regulate the output power of the power converter 12.

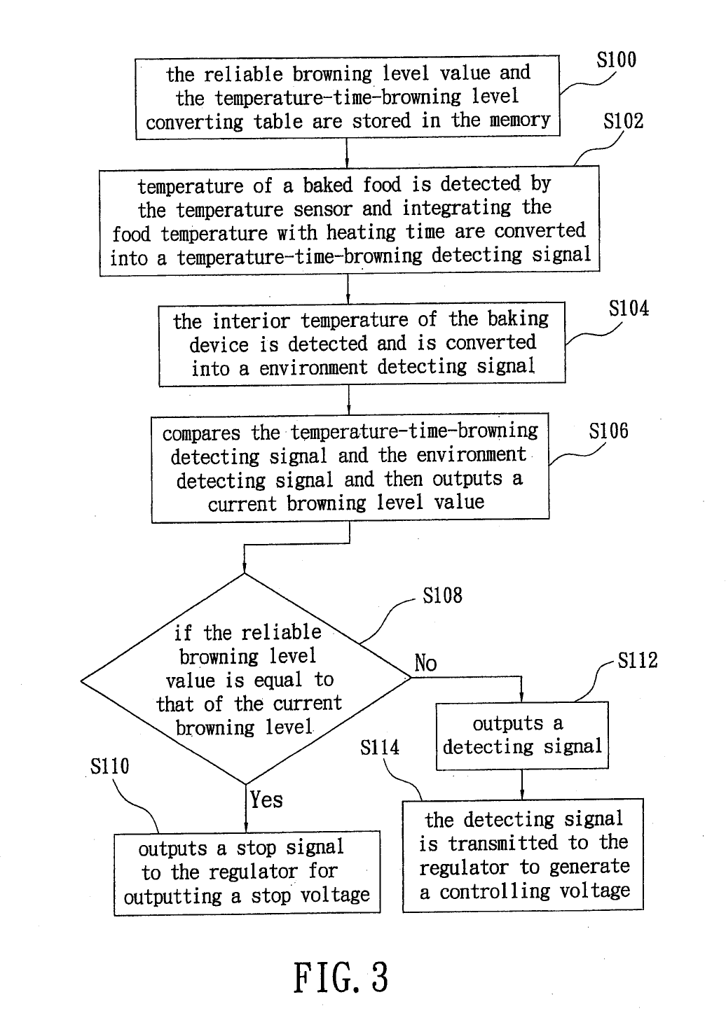

Referring to FIG. 3, a flow chart of a baking method for controlling a reliable browning level of the first embodiment of the present invention is shown. The process of baking is completed when the baking device reaches a predetermined browning level. The baking device includes a power converter 12, a thermal unit 14, a temperature sensor 16, an environment temperature sensor 18, and a microprocessor 20. Referring to FIG. 1 and FIG. 2, the baking method includes the baking device being set with a browning level knob (not shown) which provides a reliable browning level value, the reliable browning level value and the temperature-time-browning level converting table are stored in the memory 202 of the microprocessor 20 (S100).

A temperature of a baked food is detected by the temperature sensor 16 and integrating the food temperature with heating time are then converted into a temperature-time-browning detecting signal (S102). The interior temperature of the baking device is detected by the environment temperature sensor 18 and is then converted into an environment detecting signal (S104). The comparing element 204 of the microprocessor 20 compares the temperature-time-browning detecting signal and the environment detecting signal for obtaining a current browning level value (S106). The detector 206 of the microprocessor 20 judges that if the reliable browning level value is equal to that of the cur rent browning value (S108), in S108, if the judging result is true, the microprocessor 20 outputs a stop signal to the regulator 208 of the microprocessor 20 for outputting a stop voltage to stop the power converter 12 (S110). Alternatively, if the judging result is false, the microprocessor 20 outputs a detecting signal (S112), and the detecting signal is transmitted to the regulator 208 of the microprocessor 20 to generate a controlling voltage for regulating the output power of the power converter (S114).

### SECOND EMBODIMENT

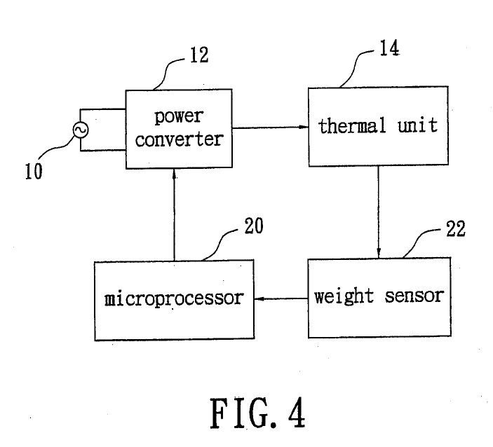

Referring to FIG. 4, a block diagram of a baking device for controlling a reliable browning level of a second embodiment of the present invention is shown. The baking device includes a power converter 12 converting an input AC power supply 10 into a DC power supply, and the AC power supply 10 may be 110Vrms/60 HZ. A thermal unit 14 is electrically connected to the power converter 12 to heat the food, and the thermal unit 14 may be a thermal grid. A weight sensor 22 is electrically connected to the thermal unit 14 to detect the weight of the baked food. A microprocessor 20 is electrically connected to the weight sensor 22 to detect the weight of the baked food, and then output a control voltage to the power converter 12.

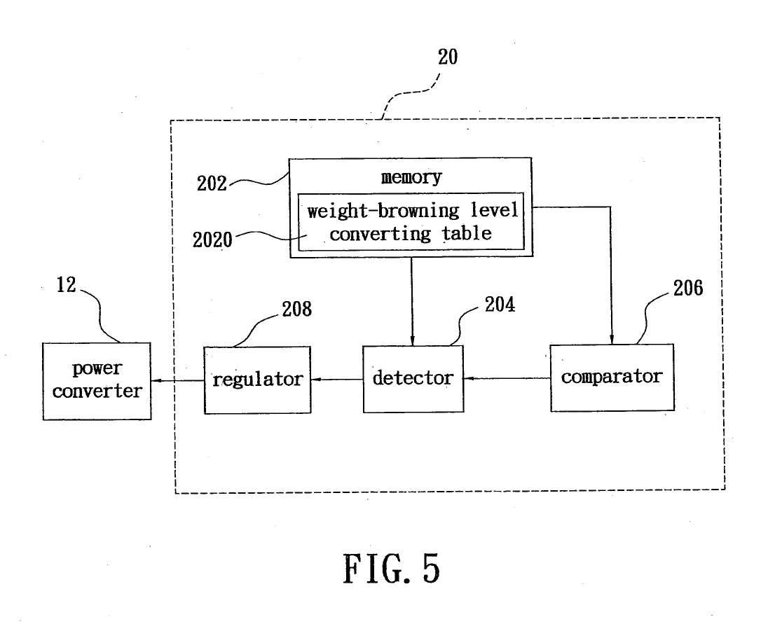

Referring to FIG. 5, a block diagram of the interior of the microprocessor unit 20 of the second embodiment of the present invention is shown. The microprocessor unit 20 includes a memory 202 storing a stable browning level value and a weight-browning level converting table 2020, the stable browning level value is provided via a browning level knob of the baking device, the memory 202 may be an EEPROM or a RAM. A detector 206 converts the weight of the baking food into a current browning level value by the weight-browning level converting table 2020. A comparing element 204 compares the percent of the current browning level and the stable browning level for providing a comparing signal, the comparing element 204 may be a comparator. A regulator 208 receives the detecting signal, and then outputs a control voltage to regulate the output power of the power converter 12.

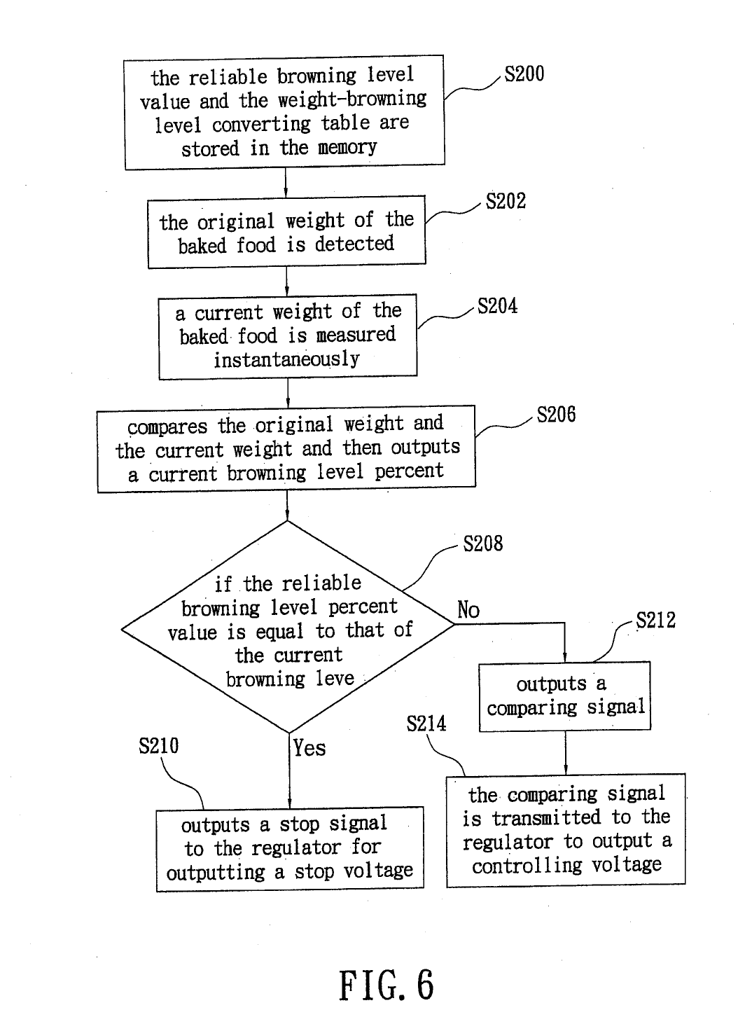

Referring to FIG. 6, a flow chart of a baking method for controlling a reliable browning level of the second embodiment of the present invention is shown. The process of baking is completed when the baking device is controlled under a reliable browning level, the baking device includes a power converter 12, a thermal unit 14, a weight sensor 22, and a microprocessor 20. Referring to FIG. 4 and FIG. 5, the baking method includes a reliable browning level value and a weight-browning level converting table 2020 provided by setting a browning level knob (not shown) on the baking device. The reliable browning level value and the weight-browning level converting table 2020 are stored in the memory 202 of the microprocessor 20 (S200).

The original weight of the baked food is detected by the weight sensor 22 (S202). The baked food is heated by the thermal unit 14 and a current weight of the baked food is measured instantaneously (S204). The comparing element 204 of the microprocessor 20 compares the original weight and the current weight and then outputs a current browning level percent (S206). The detector 206 of the microprocessor 20 determines whether the reliable browning level percent value is equal to the current browning level percent value or not (S208). If the measured result is true, the microprocessor 20 outputs a stop signal to the regulator 208 of the microprocessor 20 for outputting a stop voltage to stop the power converter 12 (S210). Alternatively, if the measured result is false, the microprocessor 20 outputs a comparing signal (S212). The comparing signal is transmitted to the regulator 208 of the microprocessor 20 to output a controlling voltage for regulating the output power of the power converter (S214).

For the second embodiment, the weight sensor weighs the original weight of the unbaked food and the weight of the baked food instantaneously. The browning level may be estimated by the percent of reduced weight, more weight percent reduced, more higher the browning level to be, heating is stopped when the weight reaches a predetermined percent.

### THIRD EMBODIMENT

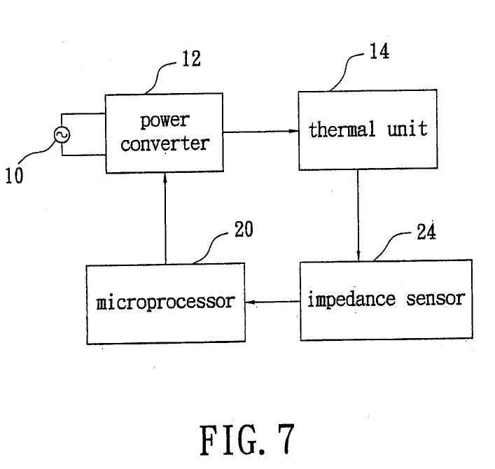

Referring to FIG. 7, a block diagram of a baking device for controlling a reliable browning level of a third embodiment of the present invention is shown. The baking device includes a power converter 12 converting an input AC power supply 10 into a DC power supply. The AC power supply 10 may be 110Vrms/60 HZ. A thermal unit 14 is electrically connected to the power converter 12 to heat up the baked food. The thermal unit 14 may be a thermal grid. An impedance sensor 24 is electrically connected to the thermal unit 14 to detect the impedance of the baked food. A microprocessor 20 is electrically connected to the impedance sensor 24 to receive the impedance of the baked food, and then outputs a control voltage to the power converter 12.

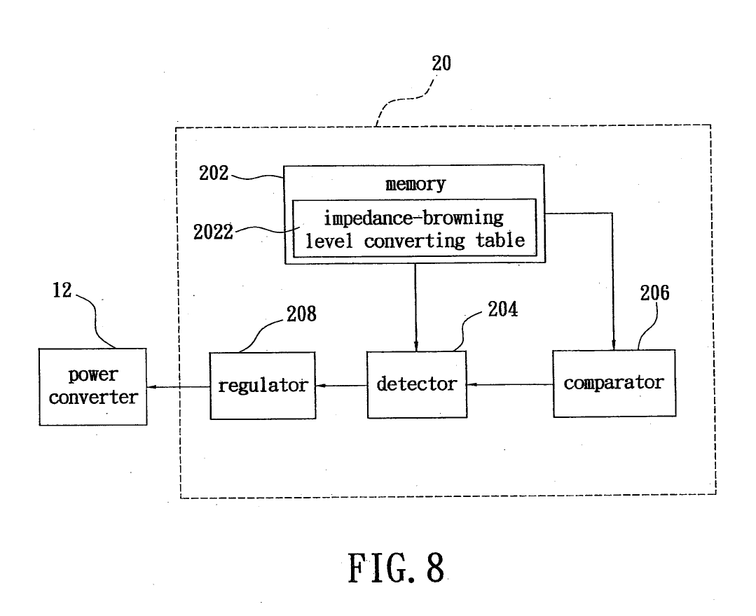

Referring to FIG. 8, a block diagram of the interior of the microprocessor unit 20 of the third embodiment of the present invention is shown. The microprocessor unit 20 includes a memory 202 storing a stable browning level value and an impedance-browning level converting table 2022. The stable browning level value is provided via a browning level knob of the baking device. The memory 202 may be an EEPROM or a RAM. A detector 206 converts the impedance of the baked food via the impedance-browning level converting table 2022 into a current browning level. A comparing element 204 compares the current browning level and the stable browning level to provide a comparing signal. The comparing element 204 may be a comparator. A regulator 208 receives the comparing signal and then outputs a controlling voltage for regulating the output power of the power converter 12.

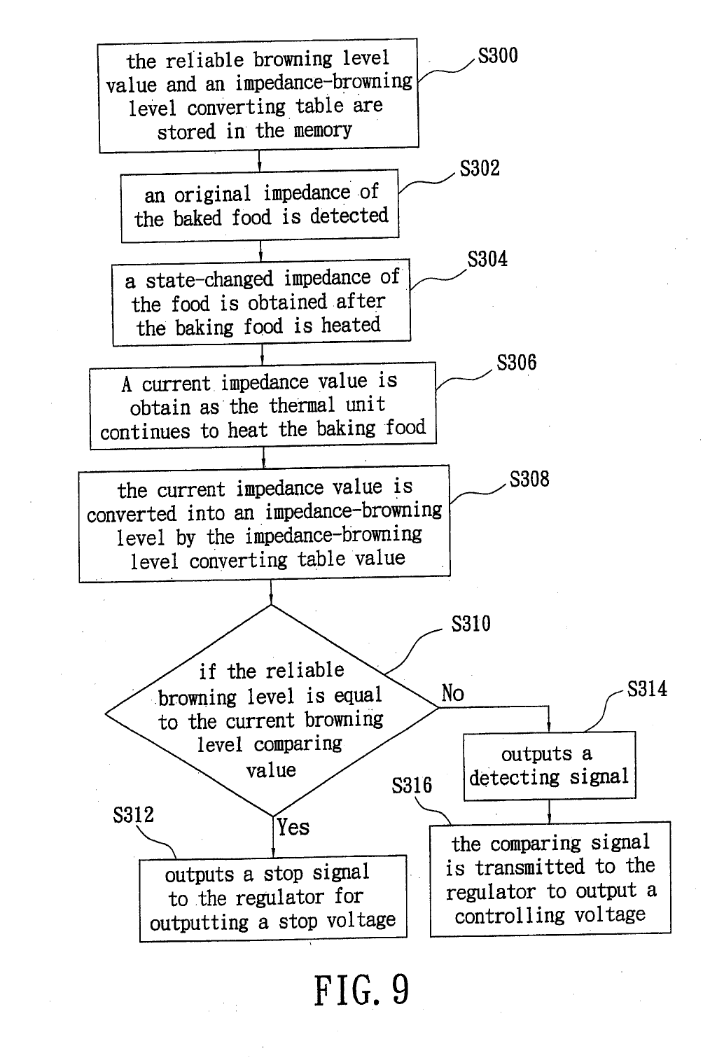

Referring to FIG. 9, a flow chart of a baking method for controlling a reliable browning level of the third embodiment of the present invention is shown. The process of the toasting is completed when the baking food reaches a predetermined browning level. The baking device includes a power converter 12, a thermal unit 14, a weight sensor 22, and a microprocessor 20. Referring to FIG. 7 and FIG. 8, the baking method includes a reliable browning level value and an impedance-browning level converting table 2022 via a browning level knob (not shown) on the baking device. The reliable browning level value and an impedance-browning level converting table 2022 are stored in the memory 202 of the microprocessor 20 (S300).

When baked food is put into the baking device to be baked, an original impedance of the baked food is detected by the impedance sensor 24 (S302). A state-changed impedance of the food is obtained after the baking food is heated by the thermal unit 14 (S304). The state-changed impedance is obtained when the baking food becomes dried, but is not yet singed. The state-changed impedance is lower than the original impedance. A current impedance value is obtained as the thermal unit 14 continues to heat the baking food (S306). The current impedance value is converted into an impedance-browning level by the impedance-browning level converting table 2022 (S308). The detector 206 of the microprocessor 20 judges if the reliable browning level is equal to the current browning level or not (S310). If the judge result is true, the microprocessor 20 outputs a stop signal to the regulator 208 of the microprocessor 20 for outputting a stop voltage to stop the power converter 12 (S312). Alternatively, if the judge result is false, the microprocessor 20 outputs a comparing signal (S314). The comparing signal is transmitted to the regulator 208 of the microprocessor 20 to output a control voltage for regulating the output power of the power converter (S316).

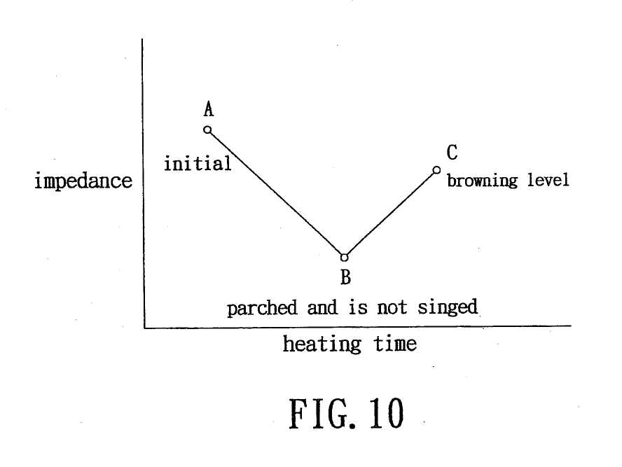

In the third embodiment, the impedance is measured via two measuring sticks placed in the baking device. Referring to FIG. 10, an impedance-time coordinates of a baked food of the present invention is shown. If the initial value of the food (point A) is somewhat high, as the food dries due to the heating process, the impedance is lower, thermal after the turning point (point B) is reached the thermal time is calculated. If the browning level (point C) is higher than the turning point (point B), the heating time is controlled by the browning level (point C). In this way, the object of the present invention, to control the heating time between point B and point C is achieved. Furthermore, the impedance may cooperate with a capacitance to bring surge, the impedance may be measured by surge frequency. Alternatively, the impedance may be obtained via Ohm's Law.

The browning level is determined by the moisture content of the baked food; the lower the moisture content, the higher the browning level. Baking device currently available to consumers use time as the only control parameter for determining the browning level, controlling the browning level via the intensity of the heated wire. However, the thickness of the baked food and the initial temperature are contribute to the end result, so the effect can often be somewhat bad. The methods provided in the three embodiments of the present invention can however, control the baking device to a reliable browning level via measuring the relationship of the moisture content of the baked food and the browning level.

What is disclosed above are only the preferred embodiments of the present invention, and it is therefore intended that the present invention not be limited to the particular embodiment disclosed. It should be understood by those skilled in the art that various equivalent changes may be made depending on the specification and the drawings of present invention without departing from the scope of the present invention.

What is claimed is:

1. A baking device for controlling a reliable browning level, comprising:
a power converter converting an input AC power supply into a DC power supply;
a thermal unit electrically connected to the power converter to heat food;
a temperature sensor electrically connected to the thermal unit to detect the temperature of the food;
a environment temperature sensor detecting the interior temperature of the baking device; and
a microprocessor electrically connected to the temperature sensor and the environment temperature sensor receiving the temperature of the baked food and the interior temperature of the baking device, and then outputting a control voltage to the power converter.

2. The baking device for controlling a reliable browning level as claimed in claim 1, wherein the thermal unit is a thermal grid.

3. The baking device for controlling a reliable browning level as claimed in claim 1, wherein the microprocessor further comprises:
a memory storing a stable browning level value and a temperature-time-browning converting table, the stable browning level value is provided via a browning level knob of the baking device;
a comparing element comparing the temperature of the baked food and the interior temperature of the baking device to provide a current browning value;
a detector judging if the reliable browning level value is equal to that the current browning value or not, and then outputting a detecting signal; and
a regulator receiving the detecting signal, and then outputting a control voltage to regulate the output power of the power converter.

4. The baking device for controlling a reliable browning level as claimed in claim 3, wherein the memory is a memorizer or a cache.

5. The baking device for controlling a reliable browning level as claimed in claim 3, wherein the comparing element is a comparator.

6. A baking method for controlling a reliable browning level, the process of the toasting being completed when the food reaches a predetermined browning level, wherein the baking device comprises a power converter, a thermal unit, a temperature sensor, a environment temperature sensor, and a microprocessor, the baking method comprising:
storing a reliable browning level value and a temperature-time-browning level provided by a browning level knob of the baking device in a memory of the microprocessor;
detecting the temperature of a baked food by the temperature sensor and integrating the food temperature with heating time and converting into a temperature-time-browning detecting signal;
detecting the interior temperature of the baking device by the environment temperature sensor and converting into a environment detecting signal;
comparing the temperature-time-browning detecting signal and the environment detecting signal via a comparing element of the microprocessor and obtaining a current browning level value;
judging whether judges the reliable browning level value is equal to that of the current browning value or not via a detector of the microprocessor;
outputting a detecting signal from the microprocessor when the judging result is true; and
transmitting the detecting signal to a regulator of the microprocessor to generate a controlling voltage for regulating the output power of the power converter.

7. The toasting method for controlling a reliable browning level as claimed in claim 6, wherein the step of judging the detector of the microprocessor, if the judging result is true, comprises the microprocessor outputs a stop signal to the regulator of the microprocessor for outputting a stop voltage to stop the power converter.

8. A baking device for controlling a reliable browning level, comprising:
a power converter converting an input AC power supply into a DC power supply;
a thermal unit electrically connected to the power converter for heating a baked food;
a weight sensor is electrically connected to the thermal unit for detecting the weight of the baked food, and
a microprocessor electrically connected to the weight sensor to measure the weight of the baked food for outputting a control voltage to the power converter.

9. The baking device for controlling a reliable browning level as claimed in claim 8, wherein the thermal unit is a thermal grid.

10. The baking device controlling a reliable browning level as claimed in claim 8, wherein the microprocessor further comprises:
a memory for storing a stable browning level value and a weight-browning level converting table;
a detector for converting the weight of the baked food into a current browning level value via the weight-browning level converting table;
a comparing element for comparing the current browning level and the stable browning level to obtain a comparing signal; and
a regulator for receiving the detecting signal to output a control voltage for regulating the output power of the power converter.

11. The baking device for controlling a reliable browning level as claimed in claim 10, wherein the memory is a memorizer or a register.

12. The baking device for controlling a reliable browning level as claimed in claim 10, wherein the comparing element is a comparator.

13. A baking method for controlling a reliable browning level, the process of the baking being completed when a baked food reaches a predetermined browning level, and the baking device comprises a power converter, a thermal unit, a weight sensor, and a microprocessor, the toasting method comprising:
storing a reliable browning level percent value and a weight-browning level converting table provided by a browning level knob of the baking device in a memory of the microprocessor;
detecting an original weight of a baked food by the weight sensor;
executing a heat of the baked food via the thermal unit and real-time measuring a current weight of the baked food;
comparing the original weight and the current weight by a comparing element of the microprocessor and obtaining a current browning level percent value;
judging whether judges the reliable browning level percent value is equal to the current browning level percent value or not via a detector of the microprocessor;
outputting a detecting signal from the microprocessor when the judging result is true; and
transmitting the detecting signal to a regulator of the microprocessor to generate a controlling voltage for regulating the output power of the power converter.

14. The baking method for controlling a reliable browning level as claimed in claim 13, wherein the current weight is converted into the current browning level percent value via the weight-browning level converting table.

15. The baking method for controlling a reliable browning level as claimed in claim 13, wherein the step of judging the detector of the microprocessor, if the judging result is true, further comprises the microprocessor outputting a stop signal from to the regulator of the microprocessor to output a stop voltage to stop the power converter.

16. A baking device for controlling a reliable browning level, comprising:
a power converter converting an input AC power supply into a DC power supply;
a thermal unit electrically connected to the power converter for heating a baked food;
an impedance sensor electrically connected to the thermal unit for detecting the impedance of the baked food; and
a microprocessor electrically connected to the impedance sensor to receive the impedance of the baked food for outputting a control voltage to the power converter.

17. The baking device for controlling a reliable browning level as claimed in claim 16, wherein the thermal unit is a thermal grid.

18. The baking device for controlling a reliable browning level as claimed in claim 16, wherein the microprocessor further comprises:
a memory for storing a stable browning level value and an impedance-browning level converting table;
a detector for converting the impedance of the baked food into a current browning level value via the impedance-browning level converting table;
a comparing element for comparing the current browning level and the stable browning level to provide a comparing signal; and
a regulator for receiving the detecting signal to output a control voltage for regulating the output power of the power converter.

19. The baking device for controlling a reliable browning level as claimed in claim 18, wherein the memory is a memorizer or a register.

20. The baking device for controlling a reliable browning level as claimed in claim 18, wherein the comparing element is a comparator.

21. A baking method for controlling a reliable browning level, the baking is completed when the baking device is controlled under a reliable browning level, and the baking device comprises a power converter, a thermal unit, an impedance sensor, and a microprocessor, the baking method comprising:
storing a reliable browning level value and a weight-browning level converting table provided by a browning level knob of the baking device in a memory of the microprocessor;
detecting an original weight of a baked food by the impedance sensor;
obtaining a state-changed impedance of the baked food after being heated by the thermal unit;
obtaining a current impedance value as the thermal unit continues to heat the baked food;
converting the current impedance value into an impedance-browning level by the impedance-browning level converting table;
detecting whether the reliable browning level is equal to the current browning level or not via a detector of the microprocessor;
outputting a comparing signal from the microprocessor when the detecting result is false, and
transmitting the comparing signal received by a regulator of the microprocessor for generating a control voltage to regulate the output power of the power converter.

22. The baking method for controlling a reliable browning level as claimed in claim 21, wherein the step of detecting whether the reliable browning level, if the detecting result is true, comprises the microprocessor outputs a stop signal to the regulator of the microprocessor to output a stop voltage to stop the power converter.
